(19) United States
(12) Patent Application Publication
(10) Pub. No.: US 2025/0171714 A1
(43) Pub. Date: May 29, 2025

(54) Candle Analysis System

(71) Applicant: Fontana Candle Company LLC, Lancaster, PA (US)

(72) Inventors: Eric Roering, Mount Joy, PA (US); Katie Roering, Mount Joy, PA (US)

(73) Assignee: Fontana Candle Company LLC, Lancaster, PA (US)

(21) Appl. No.: 18/521,320

(22) Filed: Nov. 28, 2023

(51) Int. Cl. C11C 5/02; G01N 31/12; G06T 7/00

(52) U.S. Cl. CPC C11C 5/02; G01N 31/12; G06T 7/0004; G06T 2207/10016

(57) ABSTRACT

A candle analysis system includes a camera and a testing system. The testing system has a record module and a testing module. The record module stores a plurality of candle tests in a database. Each of the candle tests is stored in the database in correspondence with a plurality of candle data and a plurality of test data for a candle that was tested in each of the candle tests. The testing module is connected to the camera and stores a video data from the camera of the candle in a burning state as part of the test data for the one of the candle tests corresponding to the candle in the video data.

### FIELD OF THE INVENTION

The present invention relates to an analysis system and, more particularly, to a system for analyzing and recording candle testing.

### BACKGROUND

Candles contain multiple components, including a container, wax, and a wick positioned in the wax, that each influence the performance of the candle when it is burned. The components of the candle are selected and tested to balance melting the wax to create a full melt pool while also ensuring that the candle can burn steadily over a sufficiently long period of time.

To determine the optimal combination of components for a candle, testers create the candle with the desired components and track the performance while the candle is burned. The tracking is currently performed entirely manually by a tester who observes the burning candle and writes information on a record sheet. The manual recordation of testing, however, is susceptible to being misplaced and, perhaps more significantly, is subjective and can vary between testers. Multiple testers may, for example, may describe the burn performance of the same wick using different language. There is thus a need for a more consistent and reliably retrievable method of testing and cataloging the performance of various candle compositions.

### SUMMARY

A candle analysis system includes a camera and a testing system. The testing system has a record module and a testing module. The record module stores a plurality of candle tests in a database. Each of the candle tests is stored in the database in correspondence with a plurality of candle data and a plurality of test data for a candle that was tested in each of the candle tests. The testing module is connected to the camera and stores a video data from the camera of the candle in a burning state as part of the test data for the one of the candle tests corresponding to the candle in the video data.

### BRIEF DESCRIPTION OF THE DRAWINGS

The invention will now be described by way of example with reference to the accompanying Figures, of which:

FIG. 1 is a block diagram of a candle analysis system according to an embodiment;

FIG. 2 is a block diagram of a database of the candle analysis system;

FIG. 3 is a flowchart of a method of analyzing a candle using the candle analysis system;

FIG. 4 is a schematic depiction of a user interface of the candle analysis system during use of the candle analysis system;

FIG. 5 is another schematic depiction of the user interface during use of the candle analysis system;

FIG. 6 is another schematic depiction of the user interface during use of the candle analysis system;

FIG. 7 is another schematic depiction of the user interface during use of the candle analysis system;

FIG. 8 is another schematic depiction of the user interface during use of the candle analysis system; and

FIG. 9 is another schematic depiction of the user interface during use of the candle analysis system.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details. Throughout the drawings, only one of a plurality of identical elements may be labeled in a figure for clarity of the drawings, but the detailed description of the element herein applies equally to each of the identically appearing elements in the figure.

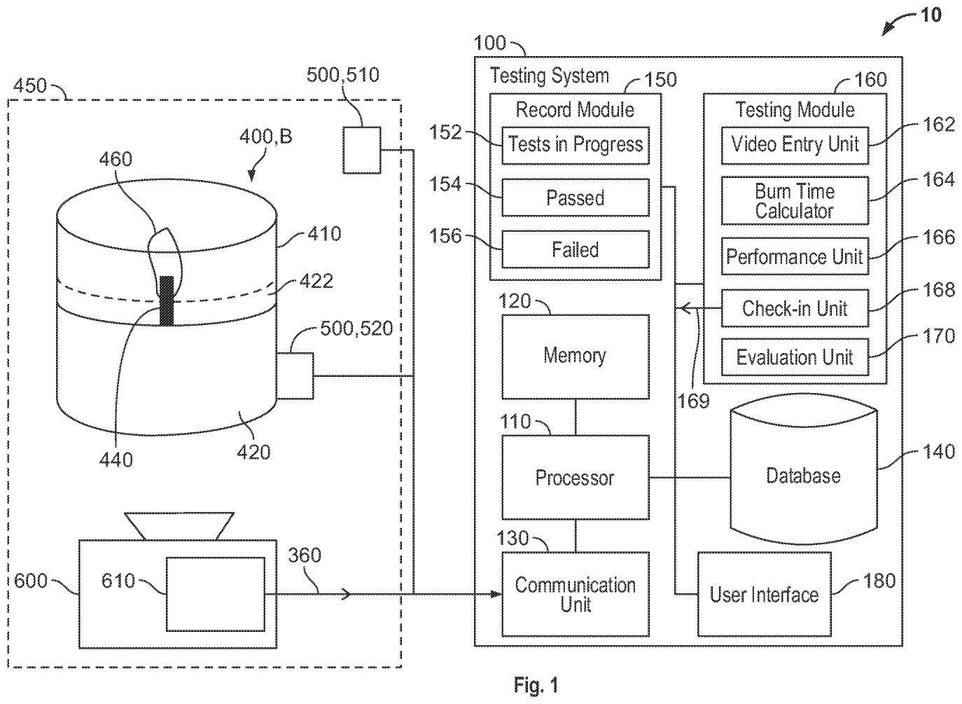

A candle analysis system 10 according to an embodiment, as shown in FIG. 1, includes a testing system 100, a plurality of sensors 500, and a camera 600 that are used to measure and record the performance of a candle 400. The components of the candle 400 to be analyzed will be first described in greater detail below, followed by a description of the components of the testing system 100, the sensors 500, and the camera 600, and then by a description of the function of the candle analysis system 10.

The candle 400, shown in FIG. 1, includes a container 410 that contains a wax 420. A fragrance 430, commonly in an oil form, is distributed throughout the wax 420 as is generally known in the art. A wick 440 is positioned in and protrudes from the wax 420 in the container 410. When the candle 400 is lit, the wick 440 has a flame 460 that melts an uppermost portion of the wax 420 to form a melt pool 422, releasing some of the fragrance 430 into the environment 450 of the candle 400.

Different candles 400 that can be analyzed with the candle analysis system 10 are selected to have different components. For example, the container 410 could be glass, ceramic, metal, concrete, or any other type of material capable of being used as a container 410 for a candle 400. The wax 420 could be beeswax, paraffin wax, soy wax, palm wax, coconut wax, or any other type of material capable of being used as a wax 420 for a candle 400. The fragrance 430 could be an oil, such as an essential oil, for example of citrus, lemon, lavender, or various other types of fragrant oils capable of being used as the fragrance 430 for a candle 400. The wick 440 may be wood, cotton, palm, hemp, or any other type of material capable of being used as a wick 440 for a candle 400. The various combinations of options for the container 410, the wax 420, the fragrance 430, and the wick 440 result in the different candles 400 that can be tested with the candle analysis system 10 for burn performance as described herein.

As shown in FIG. 1, the testing system 100 includes a processor 110, a memory 120 connected to the processor 110, a communication unit 130 connected to the processor 110, a database 140 connected to the processor 110, and a user interface 180 connected to the processor 110.

The processor 110 may be any type of computer processing device known to those with ordinary skill in the art that is capable of executing software instructions. The memory 120 is a non-transitory computer readable medium, such as read-only memory (ROM) or random-access memory (RAM), capable of storing program instructions thereon that are executable by the processor 110 to perform the functions of the processor 110 described herein.

The communication unit 130 is capable of receiving and transmitting data to and from the testing system 100, including relaying such data to the processor 110. In various embodiments, the communication unit 130 may be capable of communicating over a wired connection, a wireless connection, by near field communication, or by any other data communication of computing devices known to those with ordinary skill in the art.

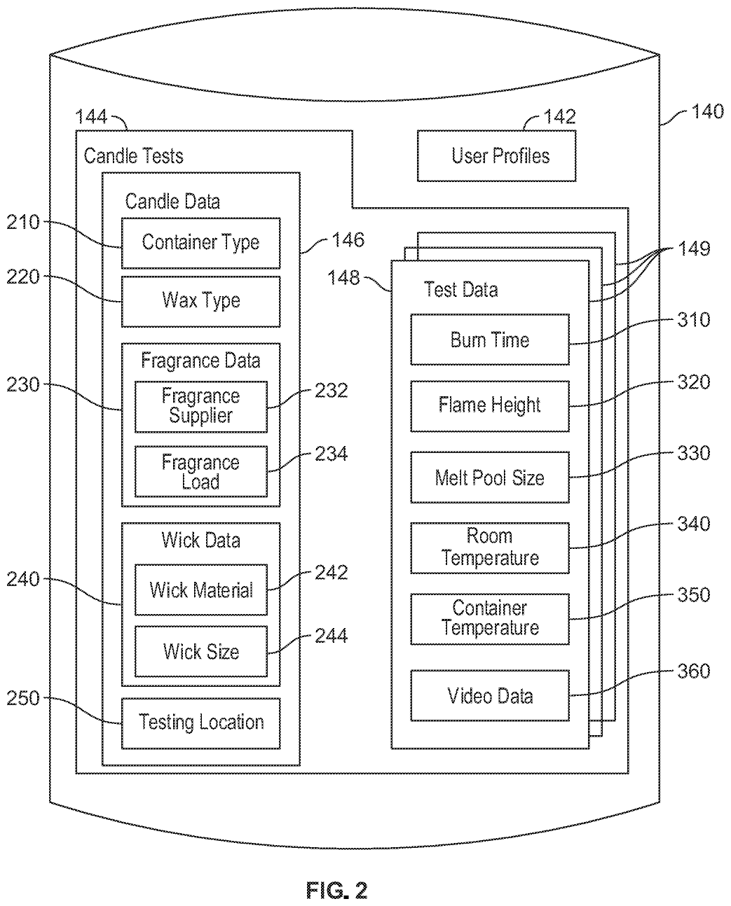

The database 140 is accessible by the processor 110. The database 140 is a non-transitory computer readable medium capable of storing data that may be located either locally or remotely from the other elements of the testing system 100. The database 140, as shown in FIG. 2, stores a plurality of user profiles 142 and a plurality of candle tests 144 that will be described in greater detail below.

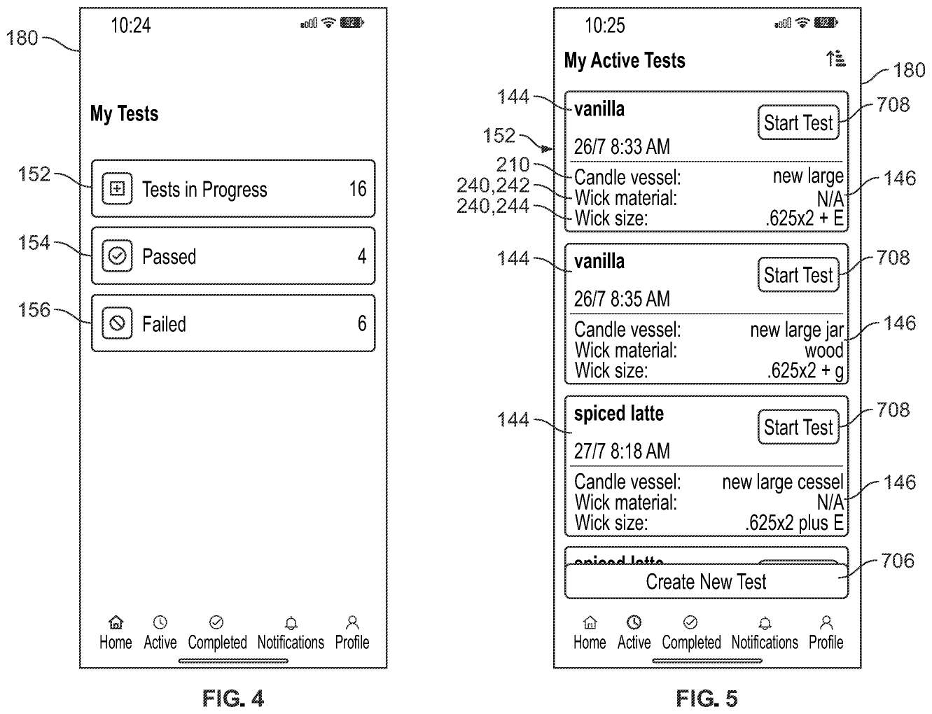

The user interface 180 is capable of receiving input data and outputting data based on instructions from the processor 110. In an embodiment in which the testing system 100 includes a desktop computer, for example, the user interface 180 may be a display, keyboard, and mouse. In another embodiment in which the testing system 100 is a mobile device, the user interface 180 may be an input-output touch screen. An exemplary user interface 180 of the testing system 100 implemented on a mobile device is shown in FIGS. 4-9. In other embodiments, the user interface 180 may be any type of computing interface known to those with ordinary skill in the art.

As shown in FIG. 1, the testing system 100 includes a record module 150 and a testing module 160 that, as described in greater detail below, are each a set of functions performed when a set of computer instructions stored on the memory 120 and corresponding to that module 150, 160 are executed by the processor 110. In the shown embodiment, the record module 150 includes categories 152, 154, 156 described in greater detail below that are differentiated by the processor 110 executing computer instructions corresponding to the record module 150 stored on the memory 120. The testing module 160 has a plurality of units 162, 166, 168, 170 and a calculator 164 that, likewise, are each a set of functions performed when a set of computer instructions stored on the memory 120 and corresponding to that part of the testing module 160 is executed by the processor 110.

The sensors 500 are a plurality of temperature sensors and include a room temperature sensor 510 and a container temperature sensor 520. The room temperature sensor 510 is positioned in the environment 450 of the candle 400 and determines the temperature of the environment 450, for example the room, in which the candle 400 is positioned. The container temperature sensor 520 is positioned adjacent to the container 410 of the candle 400 and determines the temperature of the container 410. Each of the room temperature sensor 510 and the container temperature sensor 520 may be any type of temperature sensing device, such as a thermistor, a resistance temperature detector (RTD), a thermocouple, a semiconductor-based integrated circuit, or any other type of sensing device commonly used to detect temperature.

The camera 600 is connected to the testing system 100, as shown in FIG. 1. The camera 600 may be any type of imaging device that is capable of recording and transmitting images representative of a field of view of the camera 600 in video form. The camera 600 may, for example, be a digital single-lens reflex camera. In another embodiment, the camera 600 and the testing system 100 may be housed within the same device; in this embodiment, the camera 600 may be an integral part of a mobile device such as a smart phone or a tablet and the testing system 100 may be embodied as an application and hardware that is part of the mobile device. The camera 600 has a communication unit 610 that is capable of transmitting video data 360 to the testing system 100. In various embodiments, the communication unit 610 may be capable of communicating over a wired connection, a wireless connection, by near field communication, or by any other data communication known to those with ordinary skill in the art.

The use of the candle testing system 10 to analyze and record testing of the candle 400 will now be described in greater detail. Throughout the description below, the candle analysis system 10 will primarily be described in the context of one exemplary candle 400, but the function and analysis of the candle analysis system 10 applies equally to a plurality of candles 400 formed for testing with various combinations of candle components as described above.

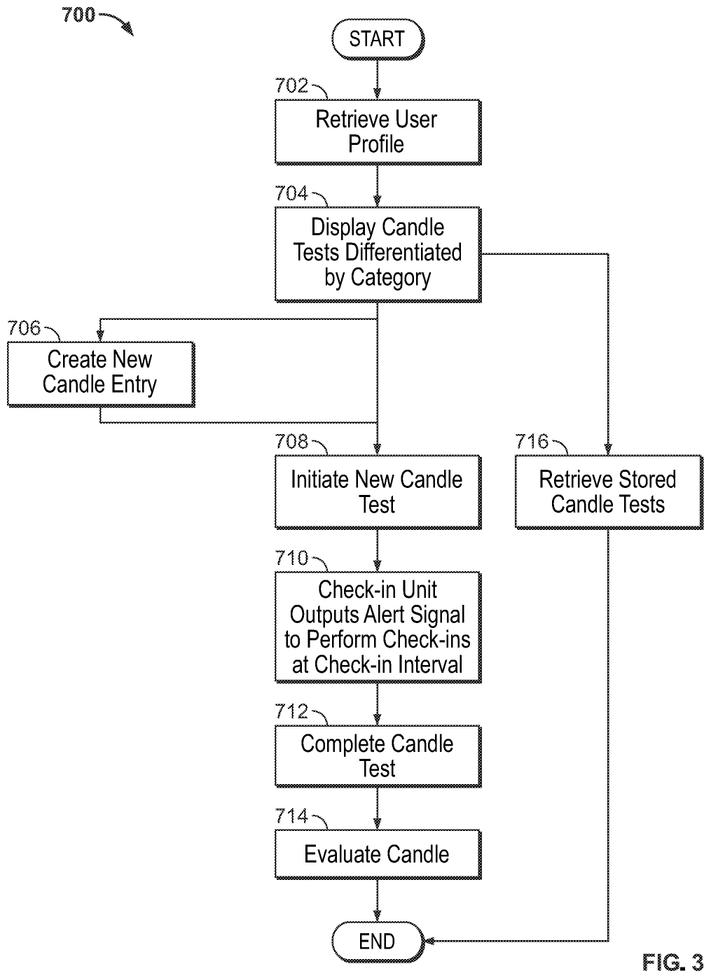

A method 700 of analyzing the candle 400 using the candle analysis system 10 is shown in FIG. 3.

In a first step 702 shown in FIG. 3, a user profile 142 is retrieved. A plurality of user profiles 142 each corresponding to one individual user or tester are stored in the database 140, as shown in FIG. 2. The user profiles 142 are organized by username and associated with a password that permits access to the user profile 142. The user enters the username and password at the user interface 180 of the testing system 100; the processor 110 executes an algorithm stored in the memory 120 to retrieve the user profile 142 associated with the username and password from the database 140. Each user profile 142 is associated with a plurality of candle tests 144 stored in the database 140.

When the user profile 142 is retrieved, the processor 110 displays the candle tests 144 stored in the database 140 associated with the user profile 142 at the user interface 180 in a step 704 shown in FIG. 3. The processor 110 executes the record module 150 to differentiate the candle tests 144 between a tests in progress category 152, a passed category 154, and a failed category 156. The various categories 152, 154, 156 are displayed on the user interface 180, as shown in FIG. 4, which indicates the number of candle tests 144 in each category 152, 154, 156. The tests in progress category 152 includes candle tests 144 that have not been completed, while the passed category 154 and the failed category 156 include candle tests 144 that have been completed and evaluated, as described in greater detail below.

Upon the selection of the tests in progress category 152 via the user interface 180 in FIG. 4, the processor 110 executes the record module 150 to retrieve the relevant candle tests 144 stored in the database 140, displaying the candle tests 144 that are tests in progress 152 for the user profile 142 on the user interface 180 as shown in FIG. 5. At this stage, the method 700 proceeds optionally through step 706 before proceeding with step 708. Selection of the passed category 154 or the failed category 156 via the user interface 180 in FIG. 4 proceeds to a different step 716 that will be described later in detail below.

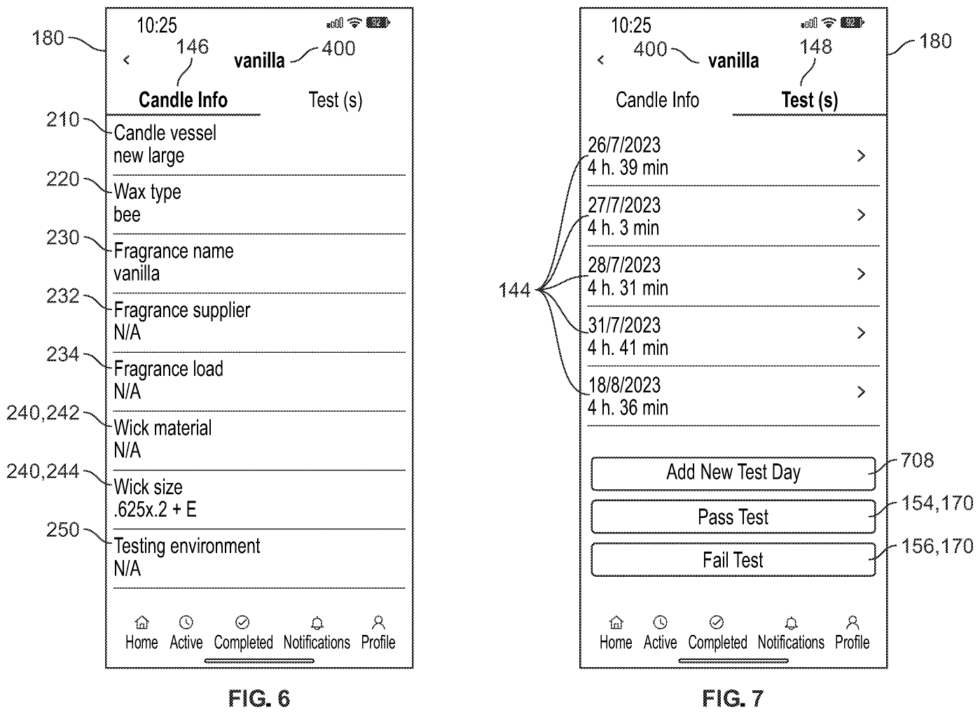

In a step 706, the user can create a new candle entry for a candle test 144 pertaining to a new type of candle 400. The new candle entry in the step 706 is initiated by selection on the user interface 180 shown in FIG. 5, which leads to the display on the user interface 180 shown in FIG. 6 that prompts the user to enter the candle data 146 on the user interface 180 related to the candle 400 of the new candle entry. The candle data 146, as shown in FIGS. 2 and 6, includes a container type 210, which is a type, size, or material of the container 410 of the candle 400, a wax type 220, which is a type of wax 420 of the candle 400, a fragrance data 230 related to the fragrance 430 used with the candle 400, a wick data 240 related to the wick 440 used with the candle 400, and a testing location 250 related to the environment 450 in which the candle 400 is tested. In the shown embodiment, the fragrance data 230 includes information on a fragrance supplier 232 that supplied or manufactured the fragrance 430 and a fragrance load 234 or relative quantity of the fragrance 430 used in the candle 400. The wick data 240, in the shown embodiment, includes information on a wick material 242 and a wick size 244. The candle data 146 entered in the step 706 is stored by the processor 110, executing the record module 150, in the database 140 in association with the user profile 142, as shown in FIG. 2.

With the new candle data 146 stored in the database 140 in the step 706, the user can then initiate a new candle test for the candle 400 in a step 708 shown in FIG. 3. Alternatively, if the candle data 146 for the candle 400 is already stored in the database 140, the user can bypass the step 706 and can initiate a new candle test for the existing candle 400 in the step 708. As shown in FIG. 5, in addition to the option to proceed to the step 706 described above, the processor 110 displays the candle tests 144 for candles 400 that have existing candle data 146 with the option to proceed to the step 708 of initiating the new candle test that creates a plurality of test data 148 for the candle 400.

The initiation of a new candle test to create test data 148 in the step 708 is shown, for example, on the user interface 180 of FIG. 7. FIG. 7 shows a plurality of candle tests 144 that have been run for a given candle 400 having particular candle data 146 stored in the database 140. The candle tests 144 are stored in correspondence with the candle data 146 and the test data 148 in the database 140. The candle 400 can have existing candle tests 144 in the database 140 when the new candle test is initiated in the step 708; more than one of the candle tests 144 in the database 140 can correspond to the same candle 400.

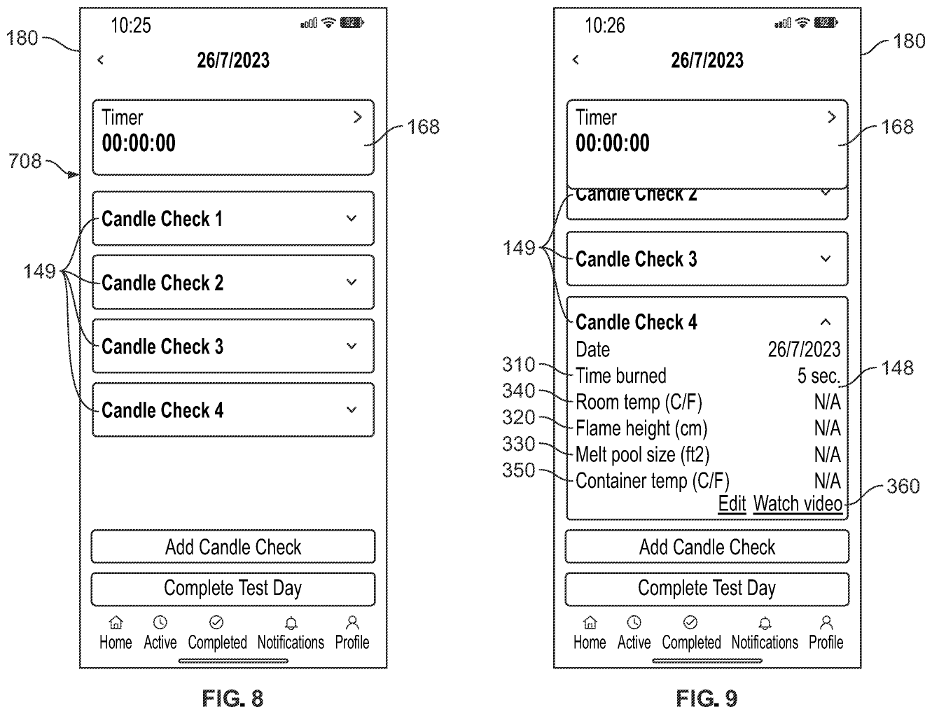

When the user initiates the new candle test to create the test data 148 in step 708, the user lights the candle 400 for testing that corresponds to the candle data 146 entered or retrieved for that test. The processor 110 executes the testing module 160 in the step 708 to initiate a check-in unit 168 of the testing module 160, shown in FIG. 1. The check-in unit 168, as shown in FIGS. 2, 8, and 9, determines a plurality of check-ins 149 for the test data 148. The plurality of check-ins 149 are checks on the performance of the candle 400 that are separated by a time interval or check-in interval throughout a testing period in which the candle 400 is in a burning state B, as shown in FIG. 1. In the exemplary embodiment shown in FIGS. 8 and 9, the testing period has four check-ins 149. In other embodiments, the user can adjust the number of check-ins 149 and the check-in interval of the check-in unit 168 through the user interface 180.

In a step 710 shown in FIG. 3, at each of the check-ins 149 on the check-in interval, the check-in unit 148 executed by the processor 110 transmits or outputs an alert signal 169 to conduct the check-in 149. As shown in FIG. 1, the alert signal 169 is sent to the user interface 180 and may be a visual, auditory, and/or haptic notification. In the embodiment shown in FIGS. 8 and 9, the check-in unit 168 is executed as a timer that provides the alert signal 169 via the user interface 180. In other embodiments, the alert signal 169 could be transmitted by the communication unit 130 remotely from the testing system 100.

At each check-in 149 in the step 710, the test data 148 is gathered and recorded for the candle 400 in the burning state B that is undergoing testing. The test data 148, as shown in FIGS. 2 and 9, includes a burn time 310, a flame height 320, a melt pool size 330, a room temperature 340, a container temperature 350, and a video data 360 at the time of the check-in 149.

The burn time 310 in the step 710 is calculated by the burn time calculator 164 of the testing module 160, shown in FIG. 1. When executed by the processor 110, the burn time calculator 164 determines the burn time 310 as a total duration that the candle 400 has been in the burning state B at the time of the check-in 149 based on a comparison of the current time and a time at which the new test was initiated in step 708. The burn time calculator 164 stores the determined burn time 310 in the test data 148 for the check-in 149, as shown in FIG. 2.

At each check-in 149 in the step 710, the alert signal 169 prompts the recording of the video data 360 by the camera 600 and the storing of the video data 360 in the test data 148 for the check-in 149. The video data 360 records the candle 400 in the burning state B for a predetermined duration at the check-in 149. In an embodiment, the video data 360 represents five seconds of the candle 400 burning at the time of the check-in 149. In other embodiments, the video data 360 could be shorter than five seconds or longer than five seconds. In an embodiment in which the camera 600 is stationary and the candle 400 remains in the field of view of the camera 600, the alert signal 169 can prompt the processor 110 to initiate the recording of the video data 360 at the camera 600. In another embodiment in which the camera 600 is part of a mobile device, the alert signal 169 can prompt the user to initiate the recording of the video data 360 at the camera 600.

The video data 360 from the camera 600, in addition to generally depicting the candle 400 in the burning state B, depicts the melt pool size 330 of the melt pool 422 and the flame height 320 of the flame 460 at the time of the check-in 149. The camera 600 transmits the video data 360 via the communication units 610, 130 and the processor 110 executes a video entry unit 162 to store the video data 360 as part of the test data 148 for the check-in 149, as shown in FIGS. 2 and 9. Additionally, in an embodiment, the user can enter the melt pool size 330, for example measured in square feet, and the flame height 320, for example measured in centimeters, measured by the user into the user interface 180 as part of the test data 148 for the check-in 149; in this embodiment, the processor 110 executes a performance unit 166 of the testing module 160 to store the entered melt pool size 330 and flame height 320 as part of the test data 148 for the check-in 149.

At each check-in 149 in the step 710, the processor 110 executes the performance unit 166 of the testing module 160 to retrieve a room temperature 340 from the room temperature sensor 510 and a container temperature 350 from the container temperature sensor 520. The room temperature 340 represents the temperature of the environment 450 in which the candle 400 is tested at the time of the check-in 149. The container temperature 350 represents the temperature of the container 410 at the time of the check-in 149. The room temperature 340 and the container temperature 350 are stored in the database 140 by execution of the performance unit 166 as part of the test data 148 for the check-in 149.

The recording of the test data 148 described above repeats for each check-in 149 in step 710 at different times over the testing period of the candle 400 in the burning state B. The test data 148 for each of the candle tests 144, as shown in FIG. 2, includes test data 148 at a plurality of different check-ins 149. The test data 148 at different check-ins 149 for the candle test 144 of a given candle 400 thus includes a plurality of different video data 360, a plurality of different temperatures 340, 350, and a plurality of different candle measurements 310, 320, 330 taken at different times and different check-ins 149 in the testing period. The candle test 144 is complete in a step 712 of FIG. 3 when the check-in unit 168 executed by the processor 110 determines that the determined number of check-ins 149 each have a set of test data 148 recorded in the database 140.

In a step 714 shown in FIG. 3, the user evaluates the candle 400 based on the candle test(s) 144 in the database 140 that corresponds to the candle 400. The user can review the candle data 146 and test data 148 across the various check-ins 149 for the candle 400. As shown in FIG. 7, the user can indicate on the user interface 180 whether the candle tests 144 belong in the passed category 154 or the failed category 156. Based on the user input, an evaluation unit 170 of the testing module 160 executed by the processor 110 indicates to the record module 150 whether the candle test(s) 144 belongs in the passed category 154 or the failed category 156. The record module 150 retains this information for future differentiation of the candle tests 144 stored in the database 140.

As described above, following step 704 in FIG. 3, the user can also select the passed category 154 or the failed category 156 view the user interface 180 in FIG. 4, which proceeds to a step 716. In the step 716, the record module 150 is executed by the processor 110 to retrieve the relevant candle tests 144 stored in the database 140 and display the candle tests 144 on the user interface 180 that are passed 154 or failed 156.

The candle analysis system 10 allows a user to test and easily track results across a range of different candle 400 compositions. Storing the candle tests 144 in the database 140 by category 152, 154, 156 allows the user to more easily determine which compositions of candles 400 have been tested, easily retrieve the data 146, 148 related to those candles 400, and determine which compositions of candles 400 perform well. Further, the integration of the testing system 100 with the sensors 500 and the camera 600 allow the user to record more advanced, objective test data 148 for each candle 400 that, for example, is not subject to interpretation of a particular user's written description of the candle 400 in the burning state B. The candle analysis system 10 thus allows for a more robust and reliable tracking of candle composition testing and performance.

What is claimed is:

1. A candle analysis system, comprising:
a camera; and
a testing system including a record module and a testing module, the record module stores a plurality of candle tests in a database, each of the candle tests is stored in the database in correspondence with a plurality of candle data and a plurality of test data for a candle that was tested in each of the candle tests, the testing module is connected to the camera and stores a video data from the camera of the candle in a burning state as part of the test data for the one of the candle tests corresponding to the candle in the video data.

2. The candle analysis system of claim 1, wherein the test data for the one of the candle tests includes a plurality of different video data, each video data is taken at a different check-in of a plurality of check-ins in a testing period of the candle.

3. The candle analysis system of claim 1, wherein more than one of the candle tests of the plurality of candle tests in the database correspond to the same candle.

4. The candle analysis system of claim 1, wherein the test data includes a flame height and a melt pool size of the candle.

5. The candle analysis system of claim 4, wherein the melt pool size and the flame height are depicted in the video data stored in the test data.

6. The candle analysis system of claim 4, wherein the test data includes a room temperature of an environment in which the candle is tested and a container temperature of a container of the candle.

7. The candle analysis system of claim 6, further comprising a plurality of sensors including a room temperature sensor and a container temperature sensor, the testing module retrieves the room temperature from the room temperature sensor and the container temperature from the container temperature sensor.

8. The candle analysis system of claim 2, wherein the testing module has a burn time calculator that determines a burn time of the candle at each of the check-ins, the burn time is a duration that the candle was in the burning state at a time of the check-in.

9. The candle analysis system of claim 2, wherein the testing module has a check-in unit that transmits an alert signal to conduct the check-ins at a check-in interval while the candle is in the burning state.

10. The candle analysis system of claim 9, wherein the alert signal prompts the recording of the video data by the camera and the storing of the video data in the test data.

11. The candle analysis system of claim 1, wherein the record module differentiates the plurality of candle tests between a tests in progress category, a passed category, and a failed category.

12. The candle analysis system of claim 11, wherein the testing module has an evaluation unit that indicates to the record module whether the candle tests belong in the passed category or the failed category.

13. The candle analysis system of claim 1, wherein the candle data includes a container type, a wax type, and a wick data for the candle.

14. The candle analysis system of claim 13, wherein the candle data include a fragrance data including a fragrance load.

15. The candle analysis system of claim 13, wherein the wick data includes a wick material and a wick size.

16. A method of analyzing a candle, comprising:
providing a camera and a testing system connected to the camera, the testing system has a record module and a testing module;
storing a plurality of candle tests in a database with the record module in correspondence with a plurality of candle data and a plurality of test data for a candle that was tested in each of the candle tests;
recording a video data of the candle in a burning state with the camera; and
storing the video data from the camera as part of the test data for the candle with the testing module.

17. The method of claim 16, wherein the video data is recorded and stored at each of a plurality of check-ins in a testing period of the candle.

18. The method of claim 17, wherein the test data includes a flame height and a melt pool size of the candle, a room temperature of an environment in which the candle is tested, and a container temperature of a container of the candle.

19. The method of claim 17, further comprising calculating a burn time of the candle at each of the check-ins, the burn time is a duration that the candle was in the burning state at a time of the check-in.

20. The method of claim 17, further comprising outputting an alert signal to conduct the check-ins at a check-in interval while the candle is in the burning state.
